(19) United States
(12) Patent Application Publication
(10) Pub. No.: US 2009/0113655 A1
(43) Pub. Date: May 7, 2009

(54) Windshield wiper airfoil device

(76) Inventor: David A. Lucker, Joseph, MI (US)

Correspondence Address: JAMES RAY & ASSOCIATES, 2640 PITCAIRN ROAD, MONROEVILLE, PA, 15146, US

(21) Appl. No.: 11/982,894

(22) Filed: Nov. 6, 2007

(51) Int. Cl. B60S 1/02

(52) U.S. Cl. 15/250.201

(57) ABSTRACT

A device that attaches to a predetermined portion of a pressure distributing superstructure of a windshield wiper blade assembly on a vehicle for preventing a flexible blade of the assembly from lifting off the windshield of the vehicle when it is traveling at a relatively high speed. The device includes an airfoil member having a substantially flat first portion and a laterally extending substantially concave second portion for deflecting high speed airflow and producing an aerodynamic force downward onto the superstructure pushing the blade against the windshield. There are a pre-selected number of elongated clip members that are affixed to a bottom surface of the first portion of the airfoil member, each including at least one protruding portion that is engageable with the superstructure of the assembly for clipping the airfoil member thereon.

### FIELD OF THE INVENTION

The present invention relates, in general, to windshield wiper blade assemblies and, more particularly, the invention relates to an airfoil device that can be attached to a predetermined portion of the superstructure of a windshield wiper blade assembly on a vehicle for preventing the flexible blade of such assembly from lifting off the windshield when the vehicle is traveling at high speed.

### BACKGROUND OF THE INVENTION

Windshield wiper blade assemblies have been in existence many years prior to the conception and development of the present invention, as is generally well known in the prior art. These assemblies are designed to clear precipitation, such as rain, sleet, snow, etc., off the windshield of a vehicle allowing better visibility for the driver of the vehicle in inclement weather conditions. However, when the vehicle is traveling at a high rate of speed, airflow moving across the windshield can cause portions of the flexible blade to lift, leading to limited visibility for the driver. This is a potentially dangerous situation not only for the driver of the vehicle but to other motorists and/or pedestrians in the vicinity as well.

### SUMMARY OF THE INVENTION

The present invention provides a device attachable to a predetermined portion of a pressure distributing superstructure of a windshield wiper blade assembly on a vehicle for preventing a flexible blade of the assembly from lifting off a windshield of the vehicle when it is traveling at high speed. The device includes an airfoil member made from a first predetermined material. The airfoil member has a substantially flat first portion and a laterally extending substantially concave second portion for deflecting high speed airflow and producing an aerodynamic force downward onto the superstructure pushing the blade against the windshield. There are a pre-selected number of elongated clip members made from a second predetermined material. Each of the clip members is affixed to a bottom surface of the first portion of the airfoil member and includes at least one protruding portion that is engageable with the superstructure of the assembly for clipping such airfoil member thereon.

### OBJECTS OF THE INVENTION

It is, therefore, one of the primary objects of the present invention to provide an airfoil device attachable to the superstructure of a windshield wiper blade assembly that helps prevent the flexible blade of such assembly from lifting off the windshield while driving at a high rate of speed.

Another object of the present invention is to provide an airfoil device that easily attaches to preexisting windshield wiper blade assemblies.

Still another object of the present invention is to provide an airfoil device that is generally easy to manufacture.

A further object of the present invention is to provide an airfoil device that is relatively inexpensive to make.

In addition to the various objects and advantages of the present invention described with some degree of specificity above it should be understood that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a perspective view of a presently preferred embodiment of an airfoil device to be attached to a windshield wiper blade assembly on a vehicle to maintain the wiper blade in contact with such windshield while driving at a relatively high rate of speed; and

FIG. 2 is a perspective view of the airfoil device illustrated in FIG. 1 as it is attached to the windshield wiper blade assembly.

### DETAILED DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

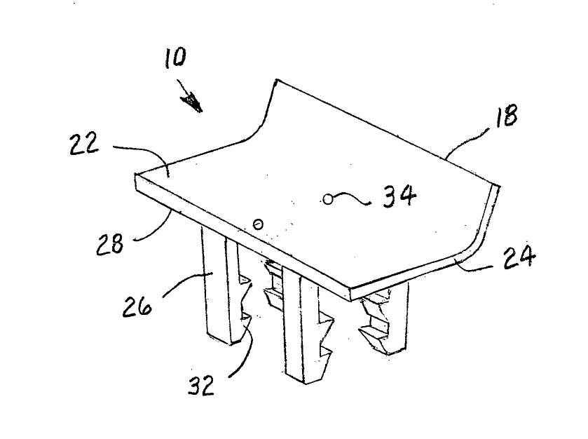

Reference is now made, more particularly, to drawing FIGS. 1-2. Illustrated therein is a device, generally designated 10, that attaches to a predetermined portion of a pressure distributing superstructure, generally designated 20, of a windshield wiper blade assembly, generally designated 30, disposed on a vehicle 12. Device 10 helps prevent flexible blade 14 of assembly 30 from lifting off windshield 16 when vehicle 12 is traveling at a relatively high rate of speed.

Device 10 includes an airfoil member 18 made from a first predetermined material. Airfoil member 18 has a substantially flat first portion 22 and a laterally extending substantially concave second portion 24 for deflecting high speed airflow and producing an aerodynamic force downward onto superstructure 20 that pushes blade 14 against windshield 16.

Device 10 further includes a pre-selected number of elongated clip members 26 made from a second predetermined material. Each of clip members 26 are affixed to a bottom surface 28 of first portion 22 of airfoil member 18. Each clip member 26 includes at least one protruding portion 32 that is engageable with superstructure 20 of assembly 30 for clipping airfoil member 18 thereon.

First portion 22 of airfoil member 18 may include a substantially centrally located aperture 34 therethrough. A tie means 36 is inserted through aperture 34 in first portion 22 and wrapped around a portion of superstructure 20 for further securing airfoil member 18 to assembly 30.

Alternatively, first portion 22 of airfoil member 18 could have a pair of substantially axially opposed apertures 34 therethrough. Tie means 36 would then be inserted through each of apertures 34 in first portion 22 and wrapped around a portion of superstructure 20 further securing airfoil member 18 to assembly 30.

In one embodiment, the number of elongated clip members 26 is two. The two clip members 26 are affixed substantially diagonally opposed to one another.

However, in the presently preferred embodiment, the number of elongated clip members 26 is four. A first pair of clip members 26 being affixed substantially axially opposed to one another and a second pair of clip members 26 being affixed substantially axially opposed to one another spaced apart from the first pair of clip members 26.

The first and second materials are, preferably, identical and selected from the group consisting of rubber, plastic and metal. Also, the first and second materials selected may either be flexible, rigid, or a combination thereof.

In one embodiment, the clip members 26 are affixed to airfoil member 18 by one of welding and adhesion. However, it is preferred that clip members 26 and airfoil member 18 be integrally molded as a single unit.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A device attachable to a predetermined portion of a pressure distributing superstructure of a windshield wiper blade assembly on a vehicle for preventing a flexible blade of such assembly from lifting off windshield when such vehicle is traveling at a predetermined relatively high speed, said device comprising:
(a) an airfoil member made from a first predetermined material, said airfoil member having a substantially flat first portion and a laterally extending substantially concave second portion for deflecting high speed airflow and producing an aerodynamic force downward onto such superstructure pushing such blade against such windshield; and
(b) a pre-selected number of elongated clip members made from a second predetermined material, each of said clip members being affixed to a bottom surface of said first portion of said airfoil member and including at least one protruding portion that is engageable with such superstructure of such assembly for clipping said airfoil member thereon.

2. A device, according to claim 1, wherein said first portion of said airfoil member includes a substantially centrally located aperture therethrough.

3. A device, according to claim 2, wherein said device further includes a tie means inserted through said aperture in said first portion and wrapped around a portion of such superstructure for further securing said airfoil member to such assembly.

4. A device, according to claim 1, wherein said first portion of said airfoil member includes a pair of substantially axially opposed apertures therethrough.

5. A device, according to claim 4, wherein said device further includes a tie means inserted through each of said apertures in said first portion and wrapped around a portion of such superstructure for further securing said airfoil member to such assembly.

6. A device, according to claim 1, wherein said pre-selected number of elongated clip members is two being affixed substantially diagonally opposed to one another.

7. A device, according to claim 1, wherein said pre-selected number of elongated clip members is four, a first pair being affixed substantially axially opposed to one another and a second pair being affixed substantially axially opposed to one another spaced apart from said first pair of elongated clip members.

8. A device, according to claim 1, wherein said first and second materials are selected from the group consisting of rubber, plastic and metal.

9. A device, according to claim 8, wherein said first and second predetermined materials are identical.

10. A device, according to claim 8, wherein said first and second materials are one of flexible, rigid and a combination thereof.

11. A device, according to claim 8, wherein said pre-selected number of clip members is affixed to said airfoil member by one of welding and adhesion.

12. A device, according to claim 8, wherein said pre-selected number of elongated clip members and said airfoil member are integrally molded as a single unit.
